(19) United States
(12) Patent Application Publication
(10) Pub. No.: US 2014/0197997 A1
(43) Pub. Date: Jul. 17, 2014

(54) ANTENNA STRUCTURE

(71) Applicant: AUDEN TECHNO.CORP., Taoyuan Hsien (TW)

(72) Inventors: Cheng-Min YANG, Taoyuan Hsien (TW); Shih-Chi LAI, Taoyuan Hsien (TW)

(73) Assignee: AUDEN TECHNO.CORP., Taoyuan Hsien (TW)

(21) Appl. No.: 13/741,021

(22) Filed: Jan. 14, 2013

(51) Int. Cl. H01Q 1/24

(52) U.S. Cl. CPC H01Q 1/243
USPC 343/702

(57) ABSTRACT

An antenna structure includes a portable electronic apparatus and an antenna. The portable electronic apparatus includes a housing. At least a metal block is arranged at a corner of the housing. The antenna is arranged in an accommodating space of the housing. The antenna includes a radiator. The radiator includes a rear end and a signal feed-in contact. A distance between the rear end, the signal feed-in contact, and the metal block is about one-fourth wavelength of communication signals, wherein the rear end faces the metal block. Therefore, the SAR of the antenna is reduced.

### BACKGROUND OF THE INVENTION

1. Field of the Invention

The present invention relates to an antenna structure, and especially relates to an antenna structure with low electromagnetic wave energy specific absorption rate (SAR).

2. Description of the Related Art

The technology is progressing every day. Therefore, many portable electronic apparatuses, such as Tablet PCs, are invented. The Tablet PCs are slim, light, portable and are used widely.

A product is tested severely before being purchased. The testing items usually include the falling test, the vibration test, the high/low temperature operation test, the EMI/EMC test, and so on. In the falling test, the product is fallen for 26 points, lines and planes. The weakest parts of the product are the corners of the housing of the product. Therefore, in order to pass the falling test more easily, the metal blocks or objects are usually arranged inside the corners of the housing of the product.

However, the specific absorption rate (SAR) of the antenna is raised because of the metal blocks or objects which are arranged inside the corners of the housing of the product. Therefore, the product cannot pass FCC SAR test.

### SUMMARY OF THE INVENTION

In order to solve the above-mentioned problems, an object of the present invention is to provide an antenna structure, wherein the direction of the rear end or the open end of the radiator of the antenna structure is changed. Therefore, the SAR of the antenna structure is still low even if the metal blocks mentioned above are arranged. The present invention is to reduce the radiation of the antenna, so that the harm to human bodies is decreased.

In order to achieve the object of the present invention mentioned above, the antenna structure includes a portable electronic apparatus and an antenna. The portable electronic apparatus includes a housing and at least a metal block. The metal block is inside the housing. The housing includes an accommodating space. The antenna is arranged in the accommodating space. The antenna includes a radiator. The radiator includes an open end and a signal feed-in contact. The open end of the antenna faces the metal block. An electric current path from the signal feed-in contact to the metal block is about one-fourth wavelength of communication signals. The accommodating space includes a plurality of corners. The metal blocks are arranged at the corners. The accommodating space includes an installation area for arranging the antenna. The metal block is arranged at the corner of the accommodating space, wherein the antenna is near the corner. The radiator includes a plurality of metal lines and a rear end. The rear end is the open end of the radiator. The radiator further includes a front end and a grounding body. The grounding body is electrically connected to the front end of the radiator.

### BRIEF DESCRIPTION OF DRAWING

FIG. 1 shows a diagram of the combination of the antenna and the portable electronic apparatus of the present invention.

FIG. 2 shows a front view of the combination of the antenna and the portable electronic apparatus of the present invention.

FIG. 3 shows a partially enlarged diagram of FIG. 2.

FIG. 4 shows a diagram of the electric current path after the antenna is arranged in the portable electronic apparatus and near the metal block.

FIG. 5 shows a comparison chart of the SAR measured on the top side of the portable electronic apparatus, wherein the rear end (open end) of the radiator of the antenna faces outside (faces the metal block) and faces inside (not faces the metal block).

FIG. 6 shows a comparison chart of the SAR measured on the back side of the portable electronic apparatus, wherein the rear end (open end) of the radiator of the antenna faces outside (faces the metal block) and faces inside (not faces the metal block).

### DETAILED DESCRIPTION OF THE INVENTION

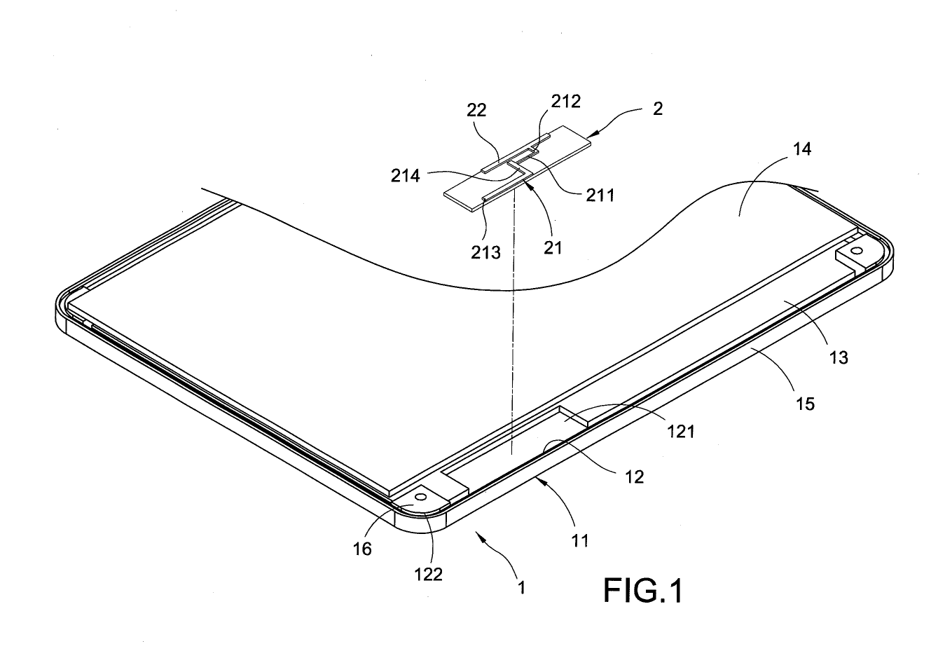

FIG. 1 shows a diagram of the combination of the antenna and the portable electronic apparatus of the present invention. The antenna structure of the present invention includes a portable electronic apparatus 1 and an antenna 2.

The portable electronic apparatus 1 includes a housing 11. The housing 11 includes an accommodating space 12. Related parts (such as a printed circuit board 13, a liquid crystal display panel 14, and a camera lens not shown in FIG. 1, and so on) of the portable electronic apparatus 1 are arranged in the accommodating space 12. An installation area 121 is formed between the printed circuit board 13, the liquid crystal display panel 14, and an edge part 15 of the housing 11 after the printed circuit board 13 and the liquid crystal display panel 14 are arranged and stacked in the accommodating space 12. Moreover, the accommodating space 12 includes four corners 122. A metal block 16 is arranged at each corner 122, or the metal block 16 is at the corner 122 which is near the antenna 2. The corners 122 of the housing 11 are tougher because of the metal blocks 16. In FIG. 1, the portable electronic apparatus 1 is a Tablet PC or a smart phone.

The antenna 2 is arranged in the installation area 121 and is at one side of the metal block 16 which is at the upper right side of the portable electronic apparatus 1. The antenna 2 includes a radiator 21 and a grounding body 22. The radiator 21 includes a plurality of metal lines 211. The radiator 21 includes a front end 212, a rear end 213, and a signal feed-in contact 214. The front end 212 is electrically connected to the grounding body 22. The rear end 213 is an open end of the antenna 2. The signal feed-in contact 214 is electrically connected to a copper axis line in the middle of a copper coaxial cable (not shown in FIG. 1). The grounding body 22 is grounded to the housing 11 of the portable electronic apparatus 1 through a grounding part of the copper coaxial cable after the grounding body 22 is electrically connected to the grounding part of the copper coaxial cable. In FIG. 1, the grounding body 22, the front end 212 of the antenna 2 and the metal lines 211 can be arranged or not arranged according to the characteristics of the antenna 2.

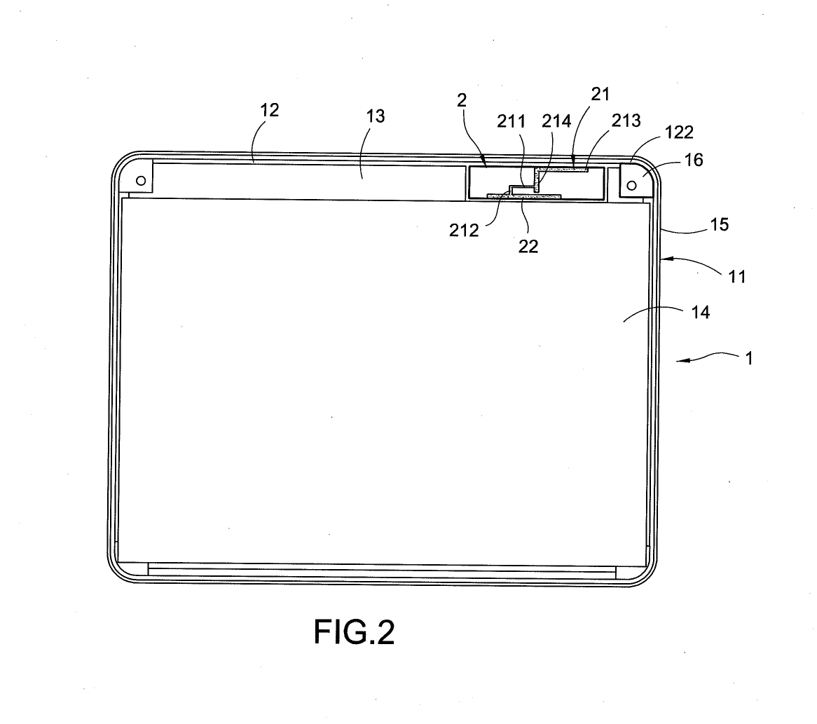

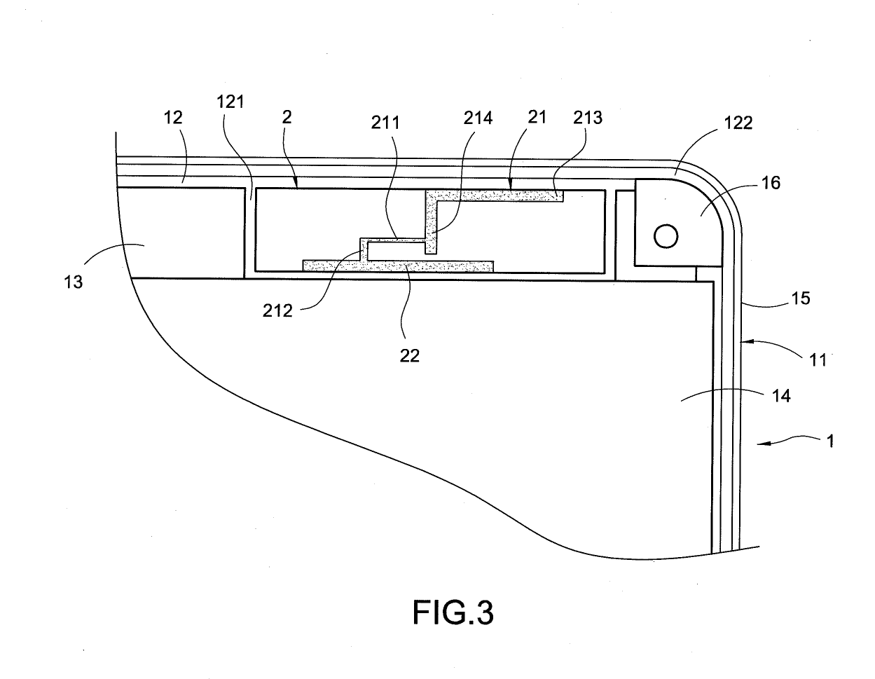

FIG. 2 shows a front view of the combination of the antenna and the portable electronic apparatus of the present invention. FIG. 3 shows a partially enlarged diagram of FIG. 2. The grounding body 22 of the antenna 2 is grounded (with copper foil stickers or conductive foams) to the housing 11 of the portable electronic apparatus 1 after the antenna 2 is arranged in the installation area 121 of the housing 11 and is near the metal block 16 which is at the upper right side of the portable electronic apparatus 1. The grounding body 22 of the antenna 2 can be grounded to a metal below the liquid crystal display panel 14 or to a grounding of the printed circuit board 13 or to any other grounding parts as well. The rear end 213 of the radiator 21 of the antenna 2 faces the metal block 16 which is at the upper right side of the portable electronic apparatus 1. A distance which is about one-fourth wavelength of communication signals is between the signal feed-in contact 214 and the metal block 16 which is at the upper right side of the portable electronic apparatus 1.

The rear end 213 of the radiator 21 of the antenna 2 faces the metal block 16 which is at the upper right side of the portable electronic apparatus 1 after the antenna 2 is arranged at one side of the metal block 16 which is at the upper right side of the portable electronic apparatus 1. The distance d, which is about one-fourth wavelength of communication signals, is between the signal feed-in contact 214 and the metal block 16 which is at the upper right side of the portable electronic apparatus 1. Therefore, the present invention is applied to 2G, 3G and 4G communication systems (WWAN, LTE). The present invention is to decrease the SAR and reduce the radiation of the antenna 2, so that the harm to human bodies is decreased.

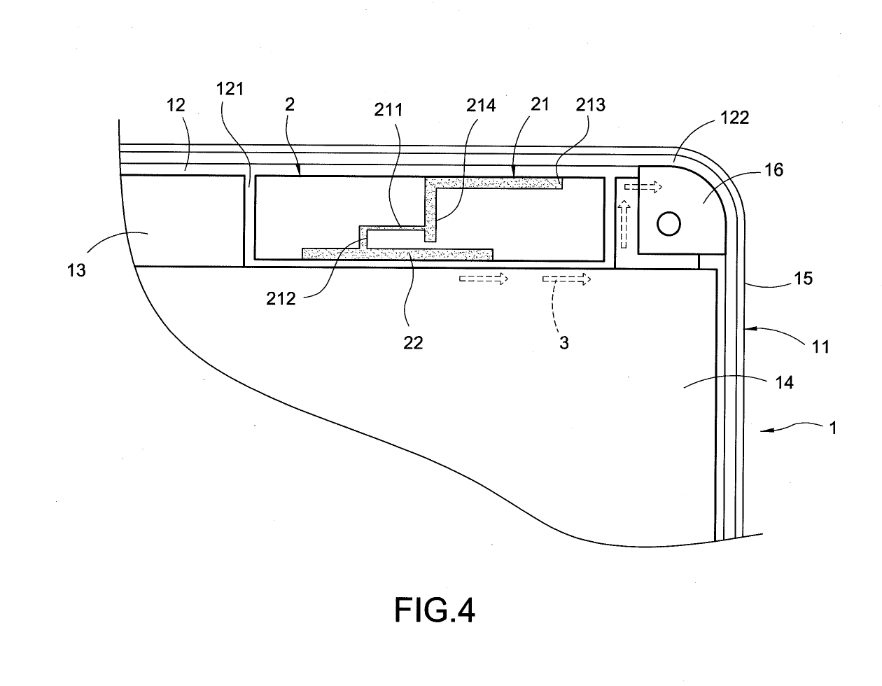

FIG. 4 shows a diagram of the electric current path after the antenna is arranged in the portable electronic apparatus and near the metal block. An electric current path 3 through the open end (facing the metal block 16) of the antenna 2, the signal feed-in contact 214 of the radiator 21 of the antenna 2, and the metal block 16 is one-fourth wavelength of communication signals after the grounding body 22 of the antenna 2 and the metal block 16 are electrically connected and arranged to the housing 11 of the portable electronic apparatus 1. Therefore, the electric current path 3 through the rear end 213 (facing the metal block 16) of the antenna 2, the signal feed-in contact 214 of the radiator 21, and the metal block 16 is about one-fourth wavelength of communication signals. The present invention is to decrease the SAR and reduce the radiation of the antenna 2, so that the harm to human bodies is decreased.

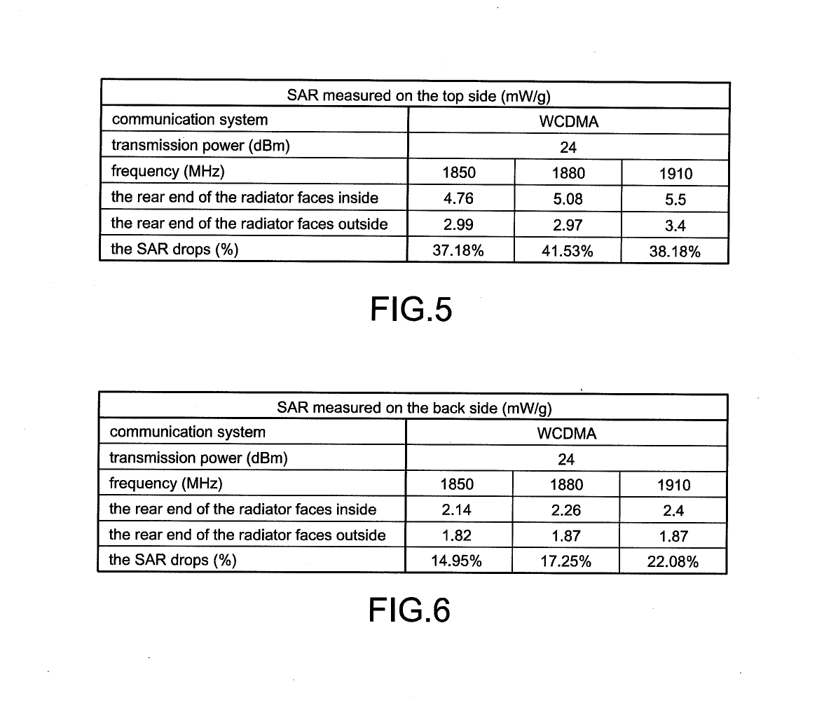

FIG. 5 shows a comparison chart of the SAR measured on the top side of the portable electronic apparatus, wherein the rear end (open end) of the radiator of the antenna faces outside (faces the metal block) and faces inside (not faces the metal block). Please refer to FIG. 1 and FIG. 2 as well. When the present invention is applied to the WCDMA communication system and the transmission power is 24 dBm and the frequency is 1850 MHz, the SAR measured on the top side of the portable electronic apparatus 1 is 4.76, wherein the rear end 213 of the radiator 21 of the antenna 2 faces inside (not faces the metal block 16). The SAR measured on the top side of the portable electronic apparatus 1 is 2.99, wherein the rear end 213 of the radiator 21 of the antenna 2 faces outside (faces the metal block 16). Therefore, the SAR drops 37.18%.

When the frequency is 1880 MHz, the SAR measured on the top side of the portable electronic apparatus 1 is 5.08, wherein the rear end 213 of the radiator 21 of the antenna 2 faces inside (not faces the metal block 16). The SAR measured on the top side of the portable electronic apparatus 1 is 2.97, wherein the rear end 213 of the radiator 21 of the antenna 2 faces outside (faces the metal block 16). Therefore, the SAR drops 41.53%.

When the frequency is 1910 MHz, the SAR measured on the top side of the portable electronic apparatus 1 is 5.5, wherein the rear end 213 of the radiator 21 of the antenna 2 faces inside (not faces the metal block 16). The SAR measured on the top side of the portable electronic apparatus 1 is 3.4, wherein the rear end 213 of the radiator 21 of the antenna 2 faces outside (faces the metal block 16). Therefore, the SAR drops 38.18%.

FIG. 6 shows a comparison chart of the SAR measured on the back side of the portable electronic apparatus, wherein the rear end (open end) of the radiator of the antenna faces outside (faces the metal block) and faces inside (not faces the metal block). Please refer to FIG. 1 and FIG. 2 as well. When the present invention is applied to the WCDMA communication system and the transmission power is 24 dBm and the frequency is 1850 MHz, the SAR measured on the back side of the portable electronic apparatus 1 is 2.14, wherein the rear end 213 of the radiator 21 of the antenna 2 faces inside (not faces the metal block 16). The SAR measured on the back side of the portable electronic apparatus 1 is 1.82, wherein the rear end 213 of the radiator 21 of the antenna 2 faces outside (faces the metal block 16). Therefore, the SAR drops 14.95%.

When the frequency is 1880 MHz, the SAR measured on the back side of the portable electronic apparatus 1 is 2.26, wherein the rear end 213 of the radiator 21 of the antenna 2 faces inside (not faces the metal block 16). The SAR measured on the back side of the portable electronic apparatus 1 is 1.87, wherein the rear end 213 of the radiator 21 of the antenna 2 faces outside (faces the metal block 16). Therefore, the SAR drops 17.25%.

When the frequency is 1910 MHz, the SAR measured on the back side of the portable electronic apparatus 1 is 2.4, wherein the rear end 213 of the radiator 21 of the antenna 2 faces inside (not faces the metal block 16). The SAR measured on the back side of the portable electronic apparatus 1 is 1.87, wherein the rear end 213 of the radiator 21 of the antenna 2 faces outside (faces the metal block 16). Therefore, the SAR drops 22.08%.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An antenna structure including:
a portable electronic apparatus having a housing and at lease a metal block, the metal block arranged in the housing, the housing including an accommodating space; and
an antenna arranged in the accommodating space, the antenna including a radiator, the radiator including an open end and a signal feed-in contact,
wherein the open end of the antenna faces the metal block; an electric current path from the signal feed-in contact to the metal block is one-fourth wavelength of communication signals.

2. The antenna structure in claim 1, wherein the accommodating space includes a plurality of corners; the metal block is arranged at the corner.

3. The antenna structure in claim 2, wherein the accommodating space includes an installation area for arranging the antenna.

4. The antenna structure in claim 3, wherein the metal block is arranged at the corner of the accommodating space; the antenna is near the corner.

5. The antenna structure in claim 4, wherein the radiator includes a plurality of metal lines.

6. The antenna structure in claim 5, wherein the radiator includes a rear end; the rear end is the open end of the radiator.

7. The antenna structure in claim 6, wherein the radiator further includes a front end.

8. The antenna structure in claim 7, wherein the radiator further includes a grounding body electrically connected to the front end of the radiator.
